(19) United States
(12) Patent Application Publication
(10) Pub. No.: US 2017/0011169 A1
(43) Pub. Date: Jan. 12, 2017

(54) INTEGRATIVE PATHWAY MODELING FOR DRUG EFFICACY PREDICTION

(71) Applicant: Medeolinx, LLC, Indianapolis, IN (US)

(72) Inventors: Jake Yue Chen, Indianapolis, IN (US); Xiaogang Wu, Indianapolis, IN (US)

(21) Appl. No.: 15/186,018

(22) Filed: Jun. 17, 2016

Related U.S. Application Data
(63) Continuation of application No. 13/690,196, filed on Nov. 30, 2012, now abandoned.
(60) Provisional application No. 61/566,641, filed on Dec. 3, 2011.
(60) Provisional application No. 61/566,642, filed on Dec. 3, 2011.
(60) Provisional application No. 61/566,644, filed on Dec. 3, 2011.

(51) Int. Cl. G06F 19/24; G06F 17/30

(52) U.S. Cl. CPC G06F 19/24; G06F 17/3053; G06F 17/30598

(57) ABSTRACT

An integrative pathway modeling approach and ranking/evaluating algorithms based on disease-specific pathway models can predict drug efficacy for patients based on their gene expression profiles. A disease-specific pathway model is first constructed with proteins and drugs important to the disease by using computational connectivity maps (C-Maps). Through the pathway model-based ranking algorithm, ideal drugs or optimized drug combination can be discovered for a patient to modulate the gene expression profile of this patient close to those in healthy individuals at pathway-level.

### PRIORITY

The present application is related to, claims the priority benefit of, and is a U.S. Continuation Application of, U.S. patent application Ser. No. 13/690,196, filed Nov. 30, 2012, which is related to, and claims the priority benefit of, a) U.S. Provisional Patent Application Ser. No. 61/566,641, filed Dec. 3, 2011, b) U.S. Provisional Patent Application Ser. No. 61/566,642, filed Dec. 3, 2011, and c) U.S. Provisional Patent Application Ser. No. 61/566,644, filed Dec. 3, 2011. The entire contents of each of the aforementioned priority applications are hereby incorporated by reference in their entirety into this disclosure.

### BACKGROUND OF THE INVENTION

### Field of the Invention

The invention relates to molecular profiling based on network modeling and analysis. More specifically, the present disclosure relates to computational methods, systems, devices and/or apparatuses for molecular expression analysis and candidate biomarker discovery.

### Description of the Related Art

Over 1500 Mendelian conditions whose molecular cause is unknown are listed in the Online Mendelian Inheritance in Man (OMIM) database. Additionally, almost all medical conditions are in some way influenced by human genetic variation. The identification of genes associated with these conditions is a goal of numerous research groups, in order to both improve medical care and better understand gene functions, interactions, and pathways. Sequencing large numbers of candidate genes remains a time-consuming and expensive task, and it is often not possible to identify the correct disease gene by inspection of the list of genes within the interval.

A number of computational approaches toward candidate-gene prioritization have been developed that are based on functional annotation, gene-expression data, or sequence-based features. High-throughput technologies have produced vast amounts of protein-protein interaction data, which represent a valuable resource for candidate-gene prioritization, because genes related to a specific or similar disease phenotype tend to be located in a specific neighborhood in the protein-protein interaction network. However, only relatively simple methods for exploring biological networks have been applied to the problem of candidate-gene prioritization, such as the search for direct neighbors of other disease genes and the calculation of the shortest path between candidates and known disease proteins.

### SUMMARY OF THE INVENTION

The invention relates to drug efficacy prediction based on pathway/network modeling and analysis. More specifically, the present disclosure relates to computational methods, systems, devices, and/or apparatuses for personalized drug or drug combination discovery on a certain disease by integrating pathway/network modeling, gene expression profiling, and pathway/network model-based ranking/evaluating algorithms.

Screening millions of chemical compounds to identify “hit” compounds for specific disease gene/protein targets has been a mainstream paradigm for modern drug discovery. While the conventional “One disease, One gene, and One drug” paradigm works effectively for simple genetic disorders, it fails to produce effective drugs for complex diseases such as cancer. In complex diseases, many genes contribute to the disease's phenotype; therefore, identifying a “magic bullet” drug compound can be quite elusive.

In systems medicine or systems pharmacology, the primary focus is to model a specific drug target's effect on metabolism, toxicity, and pharmacokinetics by examining the drug target's molecular interaction partners. However, existing methods focus on modeling the structure of the drug target network qualitatively. To examine a drug's effect on a molecular pathway representative of the disease, more quantitative and accurate pathway/network modeling and analysis techniques need to be developed.

Embodiments of the invention provide an integrative pathway modeling approach and a ranking algorithm based on integrative pathway models that can predict drug efficacy for patients. These models are based on patients' gene expression profiles. First, a disease-specific pathway model—Pharmacology Effect Network (PEN)—is constructed with important proteins and drugs by utilizing a computational connectivity maps (C-Maps) approach. In this pathway model, drug's effects on its proteins (i.e. activation/inhibition) are annotated as edge attributes. Second, a PEN-based ranking algorithm—Pharmacological Effect on Target (PET)—is developed to evaluate drug efficacy by using the gene expressions corresponding to the important proteins in the PEN model. Ideal drugs or optimized drug combinations discovered by the PEN-PET approach can modulate the gene expression profiles of patients close to those in healthy individuals at pathway-level.

In one embodiment, the present invention relates to a method for determining compounds for the treatment of a particular disease. First, a list of proteins related to the particular disease is generated. Next, a plurality of drug pathways are selected from a pathway database based on the list of proteins. Each of the drug pathways is annotated, and each drug-protein interaction on each of the drug pathways is mapped, including identifying effector proteins. The mapped drug pathways are translated into a weighted network. The ranking of the drugs associated with the drug pathways are then calculated based on the effector proteins in each of the drug pathways to provide a ranking of drugs associated with the pathways for treatment of the particular disease. The mapping step includes mapping a patient expression profile onto identified effector proteins. The generating step includes calculating a disease relevance score for each of the list of proteins. The generating step includes limiting the list of proteins to proteins having a predetermined disease relevance score. The annotating step includes associating directionality with each protein in the list of proteins, identifying effector proteins in each of the pathways, and filling holes in each of the pathways. The translating step includes classifying effector protein interaction as one of therapeutic, toxic, and ambiguous. The calculating step includes assigning a high score to drugs including therapeutic protein interactions and assigning a low score to drugs including toxic protein interactions.

In another embodiment, the present invention relates to a system for determining the efficacy of potential drugs for the treatment of a particular disease for a particular patient. A disease profile module is configured to generate a list of proteins related to the particular disease, select a plurality of drug pathways from a pathway database based on the list of proteins, provide an interface for annotating each of the plurality of drug pathways, map each drug-protein interaction on each of the plurality of drug pathways including identifying effector proteins, and translate the mapped plurality of drug pathways into a weighted network. A patient expression profile module is configured to obtain a mapping of the gene-expression profile of the particular patient onto the effectors. An evaluation module is configured to calculate a ranking of the drugs associated with the plurality of drug pathways based on the effector proteins in each of the plurality of drug pathways and the mapping of the gene-expression profile of the particular patient. The evaluation module is further configured to provide a ranking of drugs associated with the pathways for treatment of the particular disease. The disease profile module is configured to calculate a disease relevance score for each of the list of proteins. The disease profile module is configured to limit the list of proteins to proteins having a predetermined disease relevance score. The disease profile module is further configured to associate directionality with each protein in the list of proteins. The disease profile module is configured to identify effector proteins in each of the pathways. The disease profile module is also configured to fill holes in each of the pathways. The disease profile module is configured to classify effector protein interaction as one of therapeutic, toxic, and ambiguous, and to further assign a high score to drugs including therapeutic protein interactions and assign a low score to drugs including toxic protein interactions.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a schematic diagram illustrating a framework for drug efficacy prediction by using an integrative pathway modeling approach and a ranking algorithm based on the integrative pathway models.

FIG. 4 is a symbolic diagram illustrating the classification of a drug's pharmacological effect on targeted proteins.

FIG. 5 is a multi-dimensional chart diagram illustrating the heat map for a simple network shown in the left of the figure. Columns represent the edges while rows represent nodes. ‘1’ indicates activation or over-expression while ‘−1’ indicates inhibition or under-expression.

FIG. 6 is a graph diagram illustrating a breast cancer drug list with PET scores by applying the PET algorithm to two gene expression profiles (GSE10866 and GSE3193) with the PEN model. For each drug, there are two PET scores, displayed as two bars. The upper one is from GSE10866, and the lower one is from GSE3193.

FIG. 7 is a graph diagram illustrating a breast cancer drug list with PET scores by applying the PET algorithm to two gene expression profiles (GSE10866 and GSE3193) without the PEN model. For each drug, there are two PET scores, displayed as two bars. The upper one is from GSE10866, and the lower one is from GSE3193.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

In the field of molecular biology, gene expression profiling is the measurement of the activity (the expression) of thousands of genes at once, to create a global picture of cellular function including protein and other cellular building blocks. These profiles may, for example, distinguish between cells that are actively dividing or otherwise reacting to the current bodily condition, or show how the cells react to a particular treatment such as positive drug reactions or toxicity reactions. Many experiments of this sort measure an entire genome simultaneously, that is, every gene present in a particular cell, as well as other important cellular building blocks.

DNA Microarray technology measures the relative activity of previously identified target genes. Sequence based techniques, like serial analysis of gene expression (SAGE, SuperSAGE) are also used for gene expression profiling. SuperSAGE is especially accurate and may measure any active gene, not just a predefined set. The advent of next-generation sequencing has made sequence based expression analysis an increasingly popular, “digital” alternative to microarrays called RNA-Seq.

Expression profiling provides a view to what a patient's genetic materials are actually doing at a point in time. Genes contain the instructions for making messenger RNA (mRNA), but at any moment each cell makes mRNA from only a fraction of the genes it carries. If a gene is used to produce mRNA, it is considered “on”, otherwise “off”. Many factors determine whether a gene is on or off, such as the time of day, whether or not the cell is actively dividing, its local environment, and chemical signals from other cells. For instance, skin cells, liver cells and nerve cells turn on (express) somewhat different genes and that is in large part what makes them different. Therefore, an expression profile allows one to deduce a cell's type, state, environment, and so forth.

Expression profiling experiments often involve measuring the relative amount of mRNA expressed in two or more experimental conditions. For example, genetic databases have been created that reflect a normative state of a healthy patient, which may be contrasted with databases that have been created from a set of patient's with a particular disease or other condition. This contrast is relavent because altered levels of a specific sequence of mRNA suggest a changed need for the protein coded for by the mRNA, perhaps indicating a homeostatic response or a pathological condition. For example, higher levels of mRNA coding for one particular disease is indicative that the cells or tissues under study are responding to the effects of the particular disease. Similarly, if certain cells, for example a type of cancer cells, express higher levels of mRNA associated with a particular transmembrane receptor than normal cells do, the expression of that receptor is indicative of cancer. A drug that interferes with this receptor may prevent or treat that type of cancer. In developing a drug, gene expression profiling may assess a particular drug's toxicity, for example by detecting changing levels in the expression of certain genes that constitute a biomarker of drug metabolism.

For a type of cell, the group of genes and other cellular materials whose combined expression pattern is uniquely characteristic to a given condition or disease constitutes the gene signature of this condition or disease. Ideally, the gene signature is used to detect a specific state of a condition or disease to facilitates selection of treatments. Gene Set Enrichment Analysis (GSEA) and similar methods take advantage of this kind of logic and uses more sophisticated statistics. Component genes in real processes display more complex behavior than simply expressing as a group, and the amount and variety of gene expression is meaningful. In any case, these statistics measure how different the behavior of some small set of genes is compared to genes not in that small set.

One way to analyze sets of genes and other cellular materials apparent in gene expression measurement is through the use of pathway models and network models. Many protein-protein interactions (PPIs) in a cell form protein interaction networks (PINs) where proteins are nodes and their interactions are edges. There are dozens of PPI detection methods to identify such interactions. In addition, gene regulatory networks (DNA-protein interaction networks) model the activity of genes which is regulated by transcription factors, proteins that typically bind to DNA. Most transcription factors bind to multiple binding sites in a genome. As a result, all cells have complex gene regulatory networks which may be combined with PPIs to link together these various connections. The chemical compounds of a living cell are connected by biochemical reactions which convert one compound into another. The reactions are catalyzed by enzymes. Thus, all compounds in a cell are parts of an intricate biochemical network of reactions which is called the metabolic network, which may further enhance PPI and/or DNA-protein network models. Further, signals are transduced within cells or in between cells and thus form complex signaling networks that may further augment such genetic interaction networks. For instance, in the MAPK/ERK pathway is transduced from the cell surface to the cell nucleus by a series of protein-protein interactions, phosphorylation reactions, and other events. Signaling networks typically integrate protein-protein interaction networks, gene regulatory networks, and metabolic networks.

The detailed descriptions which follow are presented in part in terms of algorithms and symbolic representations of operations on data bits within a computer memory representing genetic profiling information derived from patient sample data and populated into network models. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

“PACS” refers to Picture Archiving and Communication System (PACS) involving medical imaging technology for storage of, and convenient access to, images from multiple source machine types. Electronic images and reports are transmitted digitally via PACS; this eliminates the need to manually file, retrieve, or transport film jackets. The universal format for PACS image storage and transfer is DICOM (Digital Imaging and Communications in Medicine). Non-image data, such as scanned documents, may be incorporated using consumer industry standard formats like PDF (Portable Document Format), once encapsulated in DICOM. A PACS typically consists of four major components: imaging modalities such as X-ray computed tomography (CT) and magnetic resonance imaging (MRI) (although other modalities such as ultrasound (US), positron emission tomography (PET), endoscopy (ES), mammograms (MG), Digital radiography (DR), computed radiography (CR), etc. may be included), a secured network for the transmission of patient information, workstations and mobile devices for interpreting and reviewing images, and archives for the storage and retrieval of images and reports. When used in a more generic sense, PACS may refer to any image storage and retrieval system.

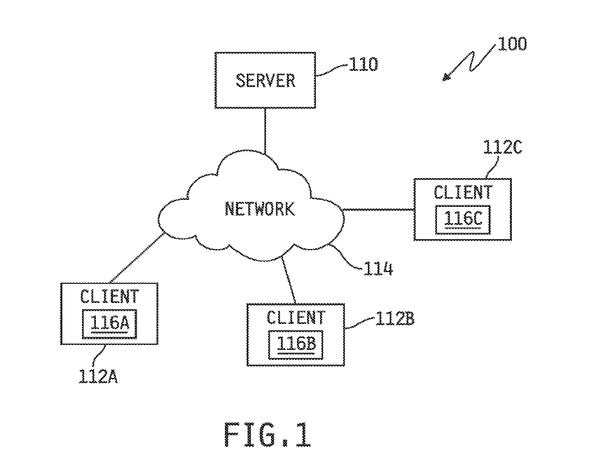

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

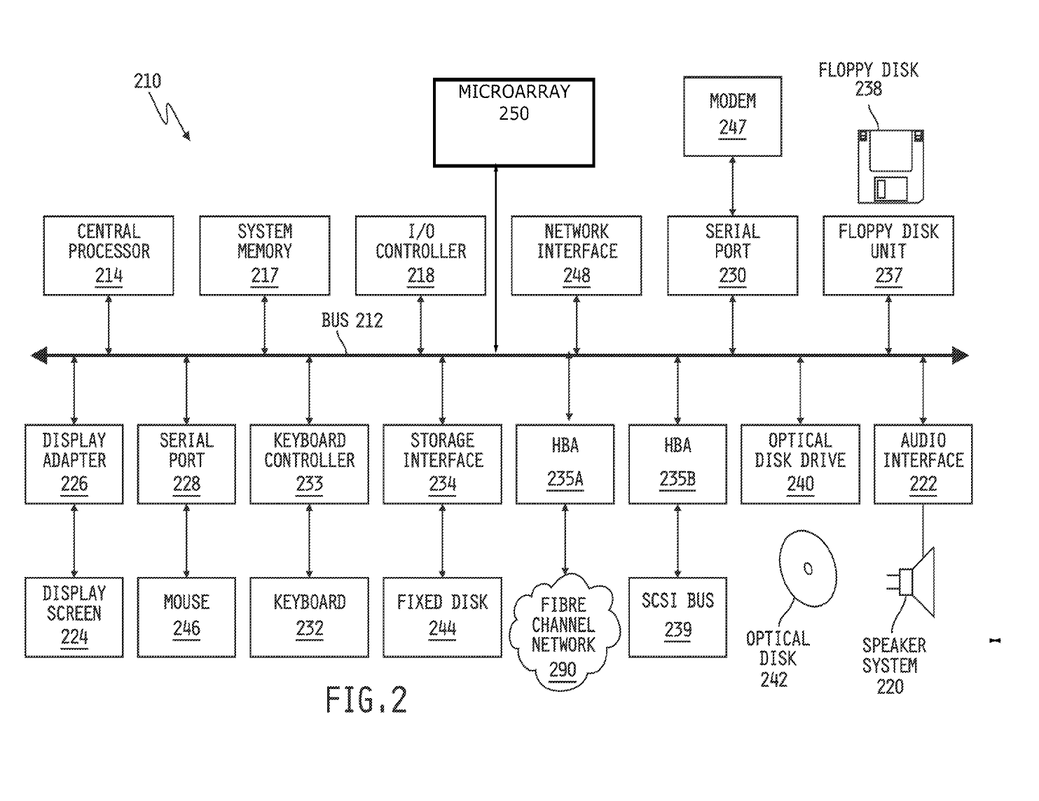

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry®Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

One peripheral device particularly useful with embodiments of the present invention is microarray 250. Generally, microarray 250 represents one or more devices capable of analyzing and providing genetic expression and other molecular information from patients. Microarrays may be manufactured in different ways, depending on the number of probes under examination, costs, customization requirements, and the type of analysis contemplated. Such arrays may have as few as 10 probes or over a million micrometre-scale probes, and are generally available from multiple commercial vendors. Each probe in a particular array is responsive to one or more genes, gene-expressions, proteins, enzymes, metabolites and/or other molecular materials, collectively referred to hereinafter as targets or target products.

In some embodiments, gene expression values from microarray experiments may be represented as heat maps to visualize the result of data analysis. In other embodiments, the gene expression values are mapped into a network structure and compared to other network structures, e.g. normalized samples and/or samples of patients with a particular condition or disease. In either circumstance, a simple patient sample may be analyzed and compared multiple times to focus or differentiate diagnoses or treatments. Thus, a patient having signs of multiple conditions or diseases may have microarray sample data analyzed several times to clarify possible diagnoses or treatments.

It is also possible, in several embodiments, to have multiple types of microarrays, each type having sensitivity to particular expressions and/or other molecular materials, and thus particularized for a predetermined set of targets. This allows for an iterative process of patient sampling, analysis, and further sampling and analysis to refine and personalize diagnoses and treatments for individuals. While each commercial vendor may have particular platforms and data formats, most if not all may be reduced to standardized formats. Further, sample data may be subject to statistical treatment for analysis and/or accuracy and precision so that individual patient data is a relevant as possible. Such individual data may be compared to large databases having thousands or millions sets of comparative data to assist in the experiment, and several such databases are available in data warehouses and available to the public. Due to the biological complexity of gene expression, the considerations of experimental design are necessary so that statistically and biologically valid conclusions may be drawn from the data.

Microarray data sets are commonly very large, and analytical precision is influenced by a number of variables. Statistical challenges include taking into account effects of background noise and appropriate normalization of the data. Normalization methods may be suited to specific platforms and, in the case of commercial platforms, some analysis may be proprietary. The relation between a probe and the mRNA that it is expected to detect is not trivial. Some mRNAs may cross-hybridize probes in the array that are supposed to detect another mRNA. In addition, mRNAs may experience amplification bias that is sequence or molecule-specific. Thirdly, probes that are designed to detect the mRNA of a particular gene may be relying on genomic Expression Sequence Tag (EST) information that is incorrectly associated with that gene.

In post-genome biology, molecular connectivity maps have been proposed to establish comprehensive knowledge links between molecules of interest in a given biological context. Embodiments of the present invention use the computational connectivity maps (C-Maps) web server, which is an online bioinformatics resource that provides biologists with potential relationships between drugs and genes in specific disease contexts, to construct an integrative disease drug-perturbation pathway/network model. Alternatively, other connectivity maps may be used, based in whole or in part on information such as that of drug perturbed gene expression profiles, the Iconix database, and the Library of Integrated Network-based Cellular Signatures (LINCS) resources.

A pathway/network model-based drug ranking algorithm is developed to evaluate the pharmacological effects of drugs on the target proteins as either “therapeutic” or “toxic”. A quantitative score for each drug can be calculated by determining the functional importance of targeted proteins, summarized pharmacological effects, and network topological features.

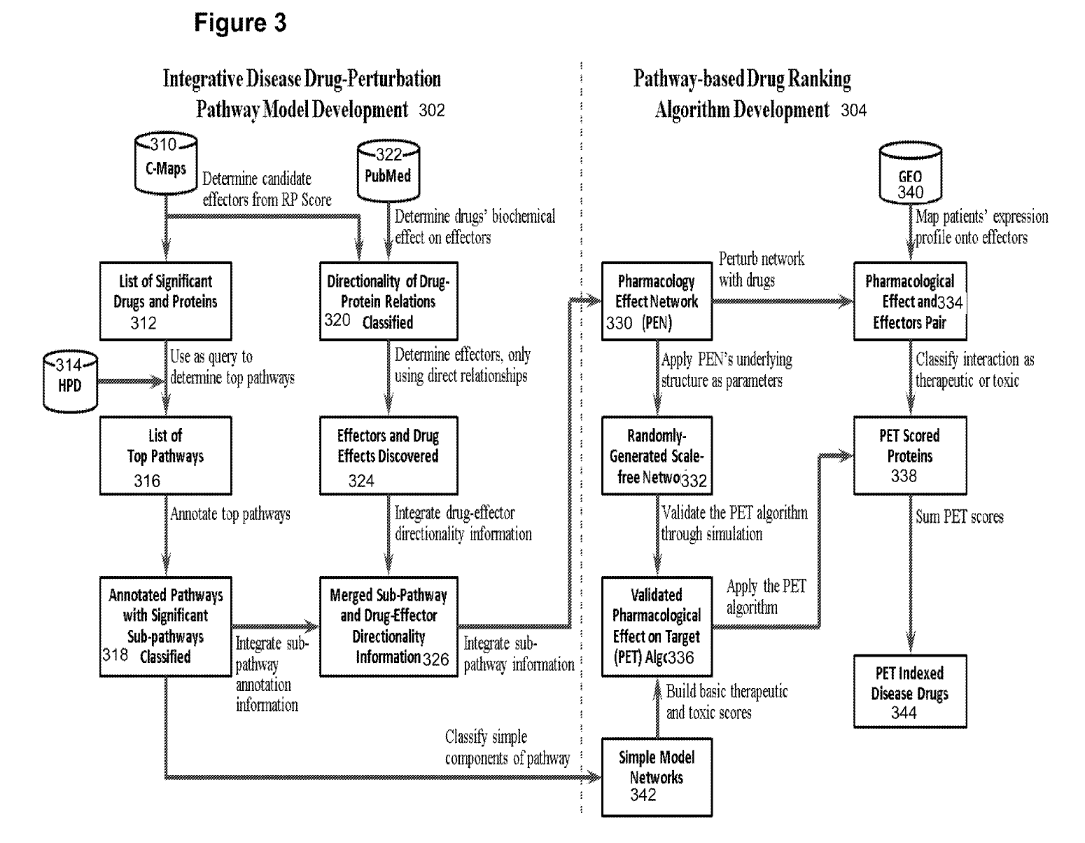

Our innovation opens a new way to evaluate the efficacy of candidate drugs or drug combinations for patients with a specific disease. The framework includes two major parts as shown in FIG. 3, the integrative disease drug-perturbation pathway model development process 302 and pathway-based drug ranking algorithm development process 304.

1. Develop Integrative Disease Drug-Perturbation Pathway Models: First, an integrated disease-specific pathway is constructed that consists of important disease-related drugs and proteins, through the C-Maps webserver 310, by simply inputting disease name. C-Maps 310 measures the importance of disease-related proteins by using RP score (for example, as may be calculated by the methodology disclosed in reference 2). After generating list 312 of important proteins for a disease, all the disease-related proteins are collectively used as a query search against the Human Pathway Database 314. This method yields comprehensive list 316 of important pathways related to the specific disease. The importance of each pathway is determined by how many proteins are included in the pathway. Each important pathway may then be annotated and, optionally, only sub-pathways with disease-related proteins are considered into list 318. Alternatively, one could use one or more these pathway or gene set data resources as substitutes for HPD 314, e.g., the Kyoto Encyclopedia of Genes and Genomes (KEGG) database by Kanehisa Laboratories, Kyoto University & University of Tokyo; the Reactome database (http://www.reactome.org) by the National Institutes of Health, Enfin of the European Union, and Ontario, Canada, New York University, and Cold Spring Harbor Laboratory; Curated Gene Signatures database (GeneSigDB at http://compbio.dfci.harvard.edu/genesigdb/), and the Pathway And Gene Enhanced Database (PAGED) database by Indiana University School of Informatics (http://bio.informatics.iupui.edu/paged/).

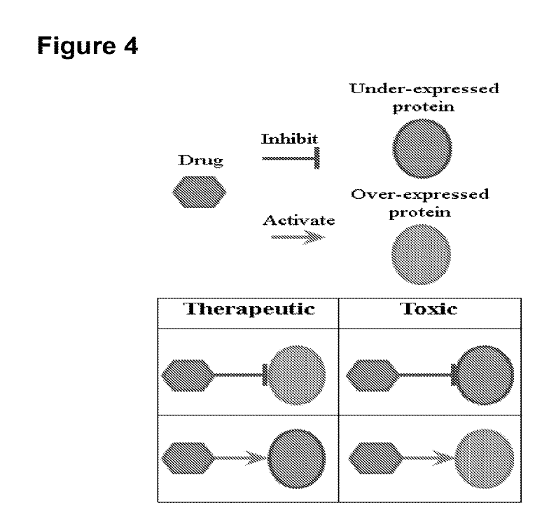

Second, directionality of protein-protein relations is obtained from the pathways that were annotated and mapped in list 320. Up-regulated relations are represented as pointed arrows and down-regulated relations are represented as flattened inhibitory arrows in FIG. 4. Any top-ranked proteins from C-Maps 310 that are not included in any existing pathway are considered as “holes”, which may be filled by using publicly available information about proteins, such as images and implementing the query term of Uniprot ID for the proteins combined with “Pathway”. By examination of the pathway images retrieved, the holes of the pathway may be filled and thus generate an integrated pathway model with important disease-related proteins and the interactions (i.e. activation, inhibition, etc.) between them.

Third, drugs are mapped to the pathway based on either drug target information from DrugBank or the drug protein pairs from C-Maps 310. To determine how a specific drug affects a specific protein, we curate all the supported abstracts from PubMed 322 for each drug-protein pair from C-Maps 310, either manually or by an automated process. Each drug-protein relation is then classified as “up-regulated”, “down-regulated”, or “other”. In step 324 a drug-protein relation is considered “up-regulated” whenever a drug positively influences a protein; “down-regulated” whenever a drug negatively influences a protein. These relations are then mapped as the edge attributes of the drug-protein interactions in 326. Alternatively, this curation of drug-protein relationships may be done with the use of a generally available natural language processing (NLP) software-based approach, or database lookup using a resource such as the Search Tool for Interactions of Chemicals (STITCH, athttp://stitch.embl.de/) database.

Finally, we translate the integrated disease-specific pathway model with mapped pharmacology effects—Pharmacology Effect Network 330 (PEN)—into a standard weighted network 332 by representing its components as an adjacency matrix and network perturbation vectors to facilitate the use of standard mathematical approaches.

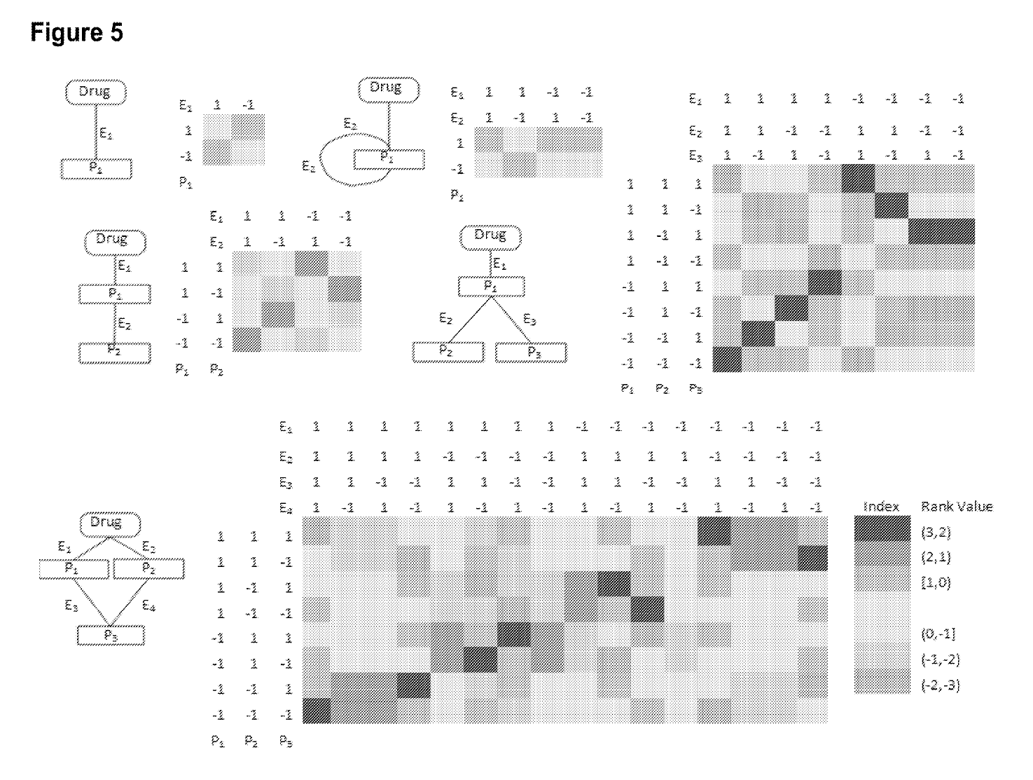

1) A standard weighted adjacency matrix, A (FIG. 5), is used to store all the protein-protein interaction information from the PEN. Each protein or protein complex, which is represented as vertex in the network, is uniquely associated with a column-row pair in the adjacency matrix so that the i-th row and column contains the edge weight, which is the protein-protein interaction directionality. Therefore, the a_{i,j} element contains the interaction between the protein associated with i-th row and j-th column of the matrix and is ‘1’ if the proteins have a stimulating relationship, ‘−1’ if the proteins have an inhibitory relationship, and ‘0’ if no direct interaction exists between the proteins.

2) The drug-target interactions from the PEN are treated separately from the protein-protein interactions and stored in a perturbation vectors, v_{d0}, where d is the drug identifier. Each drug is also a vertex with drug-protein interactions represented as edge weights. Hence, maintaining the same unique row association for proteins and protein complexes as in A, the i-th row of the vector contains the interaction directionality between the drug and row associated protein using the same weighting outlined in 1).

2. Develop PEN Model-based Drug Ranking Algorithms: Ideal drugs for a patient diagnosed with a certain disease modulates the gene expression profile of this patient (from GEO 340) to the similar level with those in healthy individuals at pathway-level, as shown in FIG. 4, we classify the drug's pharmacological effect on a protein into three categories in 334:

1) Therapeutic: if the drug activates the under-expressed protein or inhibits the over-expressed protein.

2) Toxic: if the drug activates the over-expressed protein or inhibits the under-expressed protein

3) Ambiguous: if there is missing directionality information for proteins or drugs.

The ranking algorithms assigns a high score for drugs that have a therapeutic effect on the proteins in the pathway and a low score for those that have a toxic effect on the proteins in the pathway. Since the ranking of a drug is essentially based on the Pharmacological Effect on its Targets, we call it a PET algorithm.

Since there may be multiple paths from the drug to its effected protein or effector and each one of these paths may have either a therapeutic or toxic effect, we developed an equation (1) to account for this fact. This equation is based on the information theory to score the overall effect of the specific drug to its effector.

$$w ( {N}_{m} ) = \frac{{N}_{m}}{N} {log}_{2} ( \frac{{2}^{R}}{N} ) \qquad ( 1 )$$

Where Nₘ is the number of the pharmacology effect of type m, where m=1 for therapeutic and m=2 for toxic. N is the total number of effects, and 2^{k} is a boosting factor based on the path length, k, from the drug to the effector. These two weights (w) are combined to find the overall pharmacological effect of the drug to that effector using a logistic function to scale the results.

$${r}_{i} = \frac{2}{1 + {e}^{- ( w ( {N}_{1} ) - w ( {N}_{2} ) )}} - 1 \qquad ( 2 )$$

Where rᵢ can increase if the number of therapeutic affects increase and decrease if the numbers of toxic effects increase.

In order to obtain an accurate count for N₁ and N₂, a novel way to track the perturbations spread was developed. A drug can have multiple paths towards an effector and different paths may have conflicting effects, therefore an iterative approach was employed to separately classify each of the interactions involved as therapeutic or toxic. Therefore, each protein has an interaction vector associated with it, i_{p,k}, where k is the iteration index and p the proteins identifying number in the adjacency matrix

$${i}_{p , k} = [ \begin{matrix}{N}_{1} \\ {N}_{2}\end{matrix} ] \qquad ( 3 )$$

The initial perturbation is applied by updating the directly targeted effector proteins. The effects for the next step in the perturbation are found by storing the total number of outgoing and incoming paths for each node at a given step. In this way, we can systematically trace drugs' effects on the pathway across multiple discrete steps. In order to determine the effects of the incoming perturbation, the [symbol] perturbation vector is calculated by multiplying the p-th column of A, ^{T}A^{T}(p, ;), by

[symbol]

[symbol]

,=A^{T}(p, ;) [symbol] (4)

By examining the p-th element of [symbol] , the corresponding proteins vector i_{p,k+1} is vector is updated with all incoming path effects as follows.

i_{p,k+1}=i_{p,k}=Σ_{m(p)>0}(i_{n,k}−i_{p,k-1})+Σ_{m(n)<0} inv(i_{n,k}−i_{n,k-1}) (5)

Where the inv function inverts the vector so that

$$inv ( {i}_{p , k} ) = [ \begin{matrix}{N}_{2} \\ {N}_{1}\end{matrix} ] \qquad ( 6 )$$

All incoming paths from the previous protein receive opposite classifications for the next protein in the path due to a down-regulating edge.

The final normalized PET score which contains the information of the drug's overall effect on the whole pathway was found using the following equation:

$${r}_{total} = {\sum }_{i = 0}^{n} \frac{{r}_{i}}{{\sum }_{i} Rp ( i )} \cdot \frac{n}{P} \qquad ( 7 )$$

Where n is the total number of effector proteins in the integrated pathway, m is the total number of effector proteins in the i-th drugs sub pathway, and P is the total number of proteins in the sub network for the drug.

Where n is the total number of drug affected proteins in the integrated pathway. In order to compare multiple drugs effect on the same disease, a normalized PET index is employed to account for variance in the Rp score of the proteins in a drugs effector profile.

3. Evaluate Breast Cancer Drug Efficacy by Using the PEN-PET Approach: The top 500 drug-protein relations for breast cancer from C-Maps 310 against HPD 314 are searched to retrieve the top 15 pathways. All 15 pathways are annotated and integrated. The final integrated pathway contains a total of 221 nodes. Out of the 221 nodes, 188 nodes are for proteins in the pathway with those proteins from C-Maps 314 labeled as an oval while others encased in a rectangle; 23 nodes are for drugs and 14 nodes for biological processes such as “apoptosis” and “angiogenesis”.

C-Maps 314 provide a comprehensive list of PubMed 322 abstracts for each of the 500 drug-protein relations for Breast Cancer. This amounts to over 5000 PubMed abstracts that were manually curated, classified, and categorized for breast cancer. After performing manual curation, 79 drug protein pairs contained only up information, 57 only down, 11 primarily up, 8 primarily down, and 345 unknowns.

A breast cancer PEN may be created with 23 drugs attached, including 6 FAD approved drugs for breast cancer. This network is then studied to determine compliance with the scale free property. Since PEN is a directed network, a degree distribution is generated for both in degree and out degree. Both of them show a scale free property with an R square of 0.95 for in degree and 0.96 for out degree.

PET algorithm on simple networks was tested, which are the functional building blocks of large, complex networks, such as the one drug with one target proteins, simple loop, and so on. Such testing makes sure that PET is logically correct for those simple networks. FIG. 5 shows one of the simple networks tested.

Note that the main diagonal has toxic effects due to the drug's pharmacological effect on its protein and the protein expressions in these cases having the same signs (over-expressed and activating, under expressed and inhibiting, etc.). Similarly the opposite diagonal has opposite effect types and receives largely therapeutic scores.

Then we applied PET algorithm on two breast cancer related gene expression microarray datasets (GSE3193, GSE10886), in which samples from breast cancer patients are all Estrogen Receptor positive (ER+). Differential expressed genes were mapped onto the PEN to create a disease specific network.

Of the 23 drugs tested, 3 received purely positive scores, including two popular breast cancer treatments specifically for ER+ patients, Tamoxifen and Raloxifene; 11 received purely negative PET scores, including one drug withdrawn from the market, nine drugs either the lack of any clinical trials or as with few clinical trials. Mitomycin is the only breast cancer treatment to receive a negative score across both expression profiles. As Mitomycin is an older chemotherapy drug targeting at DNA rather than specific proteins, this result was anticipated. The breast cancer drugs Exemstane, Anastrozole and Letrozole all target at CYP19A1 and thus received the same scores. Due to a mixture of therapeutic and toxic effects on effector proteins in ER+ gene expression profiles, their individual PET scores for the proteins are quite low.

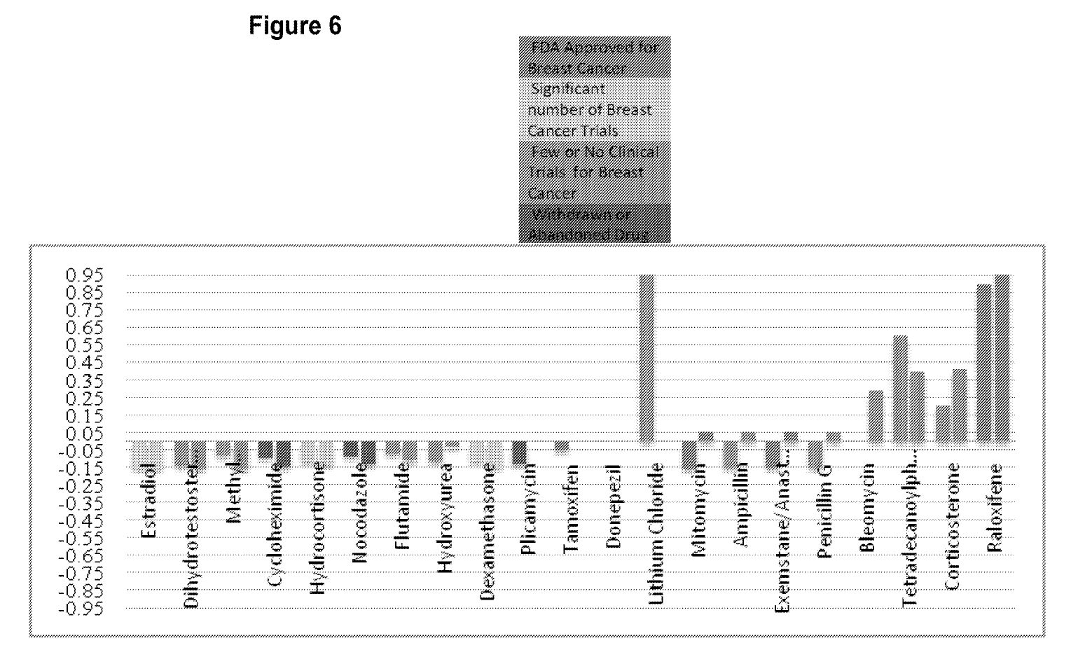

In sum, FIG. 6 shows a trend towards ranking withdrawn or abandoned drugs with a negative score while FDA approved drugs rank with a positive score; within the FDA drugs, scores favor those drugs specifically for ER+ patients since both microarray datasets are from ER+ patients.

The significance of manually curating a drugs effect on breast cancer proteins is highlighted in the case of Ralxofiene. Raloxifene targets a key breast cancer protein ESR1. It was predicted that Raloxifene would receive a highly positive score. However, contradictory information exists about the effects of this drug on ESR1. For example, in breast tissue Raloxifene inhibits ESR1, causing a therapeutic effect, but in bones, Raloxifene can activate ESR1, which would be classified as toxic. Therefore, the use of manual curation to determine the effects on ESR1 is significant so that the appropriate interaction may be selected. In FIG. 6 Raloxifene* indicates the score that Raloxifene would receive if the wrong effect had been selected.

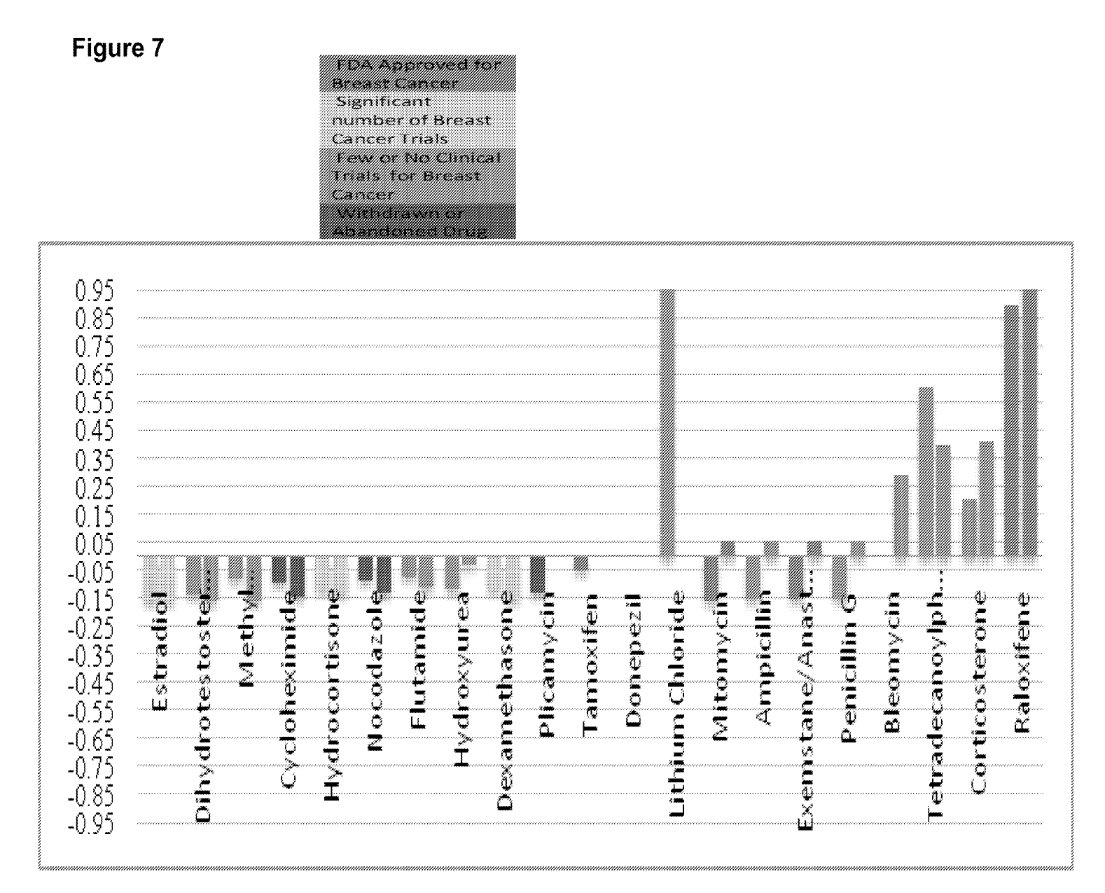

An alternate approach to rank drug's efficacy is to ignore the underlying network structure and only examine the ultimate effect of the drug on the effector proteins. This approach has previously been used. In this approach the effect on each protein is classified as either entirely toxic or entirely therapeutic. This would be the equivalent of taking only the sign of the PET score. However, as FIG. 7 demonstrates, this algorithm has trouble differentiating between drugs with therapeutic outcomes and those without.

The following references were used in the development of the present invention, and the disclosures of which are explicitly incorporated by reference herein:

1. Lamb, J., et al., The Connectivity Map: using gene-expression signatures to connect small molecules, genes, and disease. Science, 2006. 313(5795): p. 1929.

2. Li, J., X. Zhu, and J. Y. Chen, Building disease-specific drug-protein connectivity maps from molecular interaction networks and PubMed abstracts. PLoS Comput Biol, 2009. 5(7): p. e1000450.

3. Chowbina, S. R., et al., HPD: an online integrated human pathway database enabling systems biology studies. BMC Bioinformatics, 2009. 10 Suppl 11: p. S5.

4. Knox, C., et al., DrugBank 3.0: a comprehensive resource for ‘omics’ research on drugs. Nucleic acids research, 2011. 39(Database issue): p. D1035-41.

5. Hui Huang, X. W., Shuyu Li, Sara Ibrahim, Taiwo Ajumobi, and Jake Y. Chen, Evaluate Drug Effects on Gene Expression Profiles with Connectivity Maps, in 2nd International Workshop on Data Mining for Biomarker Discovery. 2010.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A system for generating a ranking of drugs for the treatment of a disease, the system comprising:
a processor; and
a plurality of modules comprising a disease profile module, a patient expression profile module, and an evaluation module, each of the plurality of modules stored on a memory and executable by the processor configured to execute operation of the plurality of modules;
wherein the disease profile module is configured to generate a list of proteins related to the particular disease and to store the list of proteins in the memory, select a plurality of pathways related to the particular disease from a pathway database accessible by the processor based on the list of proteins, provide an interface for annotating each of the plurality of pathways to generate a plurality of annotated pathways, associating directionality with each protein in the list of proteins, map each drug-protein interaction on each of the plurality of annotated pathways including identifying effector proteins, and translate and transform the mapped plurality of annotated pathways into a pharmacology effect network model, storing protein-protein interaction information from the pharmacology effect network model into a weighted matrix in the memory;
wherein the patient expression profile module is configured to obtain a mapping of the gene-expression profile of a particular patient onto the effector proteins; and
wherein the evaluation module is configured to generate a ranking of the drugs associated with the plurality of annotated pathways for treatment of a particular disease based on the effector proteins in each of the plurality of annotated pathways and the mapping of the gene-expression profile of the particular patient.

2. The system of claim 1, wherein said disease profile module is further configured to calculate a disease relevance score for each of the list of proteins.

3. The system of claim 1, wherein said disease profile module is further configured to limit the list of proteins to proteins having a predetermined disease relevance score.

4. The system of claim 1, wherein said disease profile module is further configured to associate directionality with each protein in the list of proteins.

5. The system of claim 1, wherein said disease profile module is further configured to identify the effector proteins in each of the pathways.

6. The system of claim 1, wherein said disease profile module is configured to classify effector protein interaction as one of therapeutic, toxic, and ambiguous.

7. The system of claim 6, wherein said evaluation module is configured to assign a high score to drugs including therapeutic protein interactions and assign a low score to drugs including toxic protein interactions.

8. The system of claim 6, wherein said evaluation module is configured to use the equation:
$$w ( {N}_{m} ) = \frac{{N}_{m}}{N} {log}_{2} ( \frac{{2}^{k}}{N} )$$
where w is the weight, Nₘ is the number of the pharmacology effect of type m, where m=1 for therapeutic and m=2 for toxic, N is the total number of effects, and 2^{k} is a boosting factor based on the path length, k, from the drug to the effector.

9. The system of claim 6, wherein said evaluation module is configured to scale the drug rankings by use of the equation:
$${r}_{i} = \frac{2}{1 + {e}^{- ( w ( {N}_{1} ) - w ( {N}_{2} ) )}} - 1$$
where rᵢ is a ranking score that can increase if the number of therapeutic affects increase and decrease if the numbers of toxic effects increase, where N₁ is the number of the pharmacology effect of type 1, and where N₂ is the number of the pharmacology effect of type 2.

10. A method for generating a ranking of drugs for the treatment of a disease, said method comprising executing on a processor the steps of:
generating a list of proteins related to the particular disease by processing disease-specific computational connectivity maps using the processor of a computer and storing the list of proteins in a memory of the computer;
selecting a plurality of pathways related to the particular disease from a pathway database using the processor based on the list of proteins;
annotating each of the plurality of pathways using the processor to generate a plurality of annotated pathways including sub-pathways with disease-related proteins therein, associating directionality with each protein in the list of proteins;
mapping each drug-protein interaction on each of the plurality of annotated pathways including identifying effector proteins and mapping a gene-expression profile of a particular patient onto the identified effector proteins using the processor;
translating and transforming the mapped plurality of annotated pathways into a pharmacology effect network model using the processor, storing protein-protein interaction information from the pharmacology effect network model into a weighted matrix in the memory; and
generating a ranking of the drugs associated with the plurality of annotated pathways for treatment of a particular disease using the processor based on the effector proteins in each of the plurality of annotated drug pathways and the mapping of the gene-expression profile of the particular patient.

11. The method of claim 10, further comprising the step of:
administering at least one drug from the ranking of drugs to the particular patient to treat the particular disease

12. The method of claim 10, wherein the generating step includes calculating a disease relevance score for each of the list of proteins.

13. The method of claim 12, wherein the generating step includes limiting the list of proteins to proteins having a predetermined disease relevance score.

14. The method of claim 10, wherein the annotating step includes identifying effector proteins in each of the pathways.

15. The method of claim 10, wherein the annotating step includes filling holes in each of the pathways.

16. The method of claim 10, wherein the translating step includes classifying effector protein interaction as one of therapeutic, toxic, and ambiguous.

17. The method of claim 16, wherein the calculating step includes assigning a high score to drugs including therapeutic protein interactions and assigning a low score to drugs including toxic protein interactions.

18. The method of claim 17, wherein the calculating step uses the equation:
$$w ( {N}_{m} ) = \frac{{N}_{m}}{N} {log}_{2} ( \frac{{2}^{k}}{N} )$$
where w is the weight, Nₘ is the number of the pharmacology effect of type m, where m=1 for therapeutic and m=2 for toxic, Nis the total number of effects, and 2^{k} is a boosting factor based on the path length, k, from the drug to the effector.

19. The method of claim 11, whereby the method is performed using a system, the system comprising:
a disease profile module configured to perform the generating step, the selecting step, the annotating step, the first mapping step, and the translating step;
a patient expression profile module configured to perform the second mapping step; and
an evaluation module configured to perform the calculating step.

20. A computer program product for generating a ranking of drugs for the treatment of a disease, the computer program product comprising:
a non-transitory computer readable storage medium having computer readable program code embodied therewith, the computer readable program code comprising:
computer readable program code for generating a list of proteins related to the particular disease by processing disease-specific computational connectivity maps using a processor of a computer in communication with the storage medium and storing the list of proteins in the storage medium of the computer;
computer readable program code for selecting a plurality of pathways related to the particular disease from a pathway database using the processor based on the list of proteins;
computer readable program code for annotating each of the plurality of pathways using the processor to generate a plurality of annotated pathways including sub-pathways with disease-related proteins therein, associating directionality with each protein in the list of proteins;
computer readable program code for mapping each drug-protein interaction on each of the plurality of annotated pathways including identifying effector proteins and mapping a gene-expression profile of a particular patient onto the identified effector proteins using the processor;
computer readable program code for translating and transforming the mapped plurality of annotated pathways into a pharmacology effect network model using the processor, storing protein-protein interaction information from the pharmacology effect network model into a weighted matrix in the storage medium; and
computer readable program code for generating a ranking of the drugs associated with the plurality of annotated pathways for treatment of a particular disease using the processor based on the effector proteins in each of the plurality of annotated drug pathways and the mapping of the gene-expression profile of the particular patient.
